(19) United States
(12) Patent Application Publication
(10) Pub. No.: US 2014/0370606 A1
(43) Pub. Date: Dec. 18, 2014

(54) METHOD FOR ESTIMATING THE DEAD TIME OF A LAMBDA SENSOR OF AN EXHAUST GAS PURIFYING DEVICE

(71) Applicant: Audi AG, Ingolstadt (DE)

(72) Inventor: Bodo Odendall, Lenting (DE)

(21) Appl. No.: 14/365,434

(22) PCT Filed: Dec. 5, 2012
(86) PCT No.: PCT/EP2012/005003

§ 371 Date: Jun. 13, 2014

(30) Foreign Application Priority Data
Dec. 14, 2011 (DE) 10 2011 121 099.0

(51) Int. Cl. B01D 53/34; G01N 31/10

(52) U.S. Cl. CPC B01D 53/346; G01N 31/10
USPC 436/37; 422/116

(57) ABSTRACT

In a method for operating an exhaust gas purifying device, with at least one catalyst for filtering exhaust gas and at least one lambda sensor arranged in the exhaust gas, an end of a time period assigned to a maximum or minimum of a delayed signal value supplied by the lambda sensor is determined in that a variable value tracks the signal value and, if the signal value falls short of or exceeds the variable value by a specific difference value, the end of the time period is determined. The end of a time period is corrected on the basis of the time constant of the delay.

The invention relates to a method for operating an exhaust gas purifying device with at least one catalytic converter for filtering exhaust gas and with at least one lambda probe arranged in the exhaust gas, wherein an end of a time period which is assigned to a maximum or minimum of a delayed signal value provided by the lambda probe is determined by comparing a variable value to the signal value and the end of the time period is determined when the signal value falls below or exceeds the variable value by a defined differential value. The invention also relates to an exhaust gas purification device.

Methods of the aforementioned type are known from the state of the art. They serve for operating the exhaust gas purifying device. The latter includes the at least one catalytic converter which serves for filtering for example exhaust gas and is assigned to for example an exhaust tract of an internal combustion engine The catalytic converter is thus impinged with exhaust gas generated by the internal combustion engine. Beside the catalytic converter the exhaust gas purifying device includes the at least one lambda probe which is arranged so that the exhaust gas flows over it. The lambda probe can for example be arranged upstream or downstream of the catalytic converter.

Combustion of fuel in the internal combustion engine requires a defined amount of an oxidator is required for a defined amount of the fuel. Usually the oxygen present in the ambient air is used as oxidator. The ratio between the amount of air actually introduced into the internal combustion engine or its at least one a combustion chamber and a theoretically required amount of air is referred to as lambda value (λ). When λ=1 an amount of air is supplied into the internal combustion engine which is optimal for the combustion. However, when the internal combustion engine is constructed as Otto combustion engine it achieves its highest performance at air deficiency, i.e., at about 0.9≦λ≦1. On the other hand the lowest fuel consumption is achieved at about 10% air excess (corresponding to λ=(about) 1.1).

The catalytic converter serves for converting pollutants contained in the exhaust gas into products which are less deleterious for the environment of the motor vehicle. Reliable function of the catalytic converter however requires determining the proportion of oxygen in the exhaust gas. For this purpose the lambda probe is required. The signal value provided by the lambda probe indicates the degree of combustion of the fuel-air mixture present in the combustion chambers of the internal combustion engine. In particular diagnosing the lambda probe and/or the catalytic converter requires determining the period of time between changing the fuel-to-air ratio of the fuel-air mixture introduced into the internal combustion engine and the corresponding changes of the signal value provided by the lambda probe. This is in particular relevant when the diagnosis of the catalytic converter and the diagnosis of the lambda probe is to be performed at the same time. When changing the fuel-air mixture toward lean (λ decreases) the maximum of the signal A provided by the lambda probe or the time point assigned to the maximum is determined. Correspondingly, when the fuel-air mixture is changed toward rich (λ increases) the minimum or the time point assigned to the minimum is determined. The time points define the end of the time period which lies for example between the time point of setting the new fuel-air mixture and the time point assigned to the maximum or the minimum of the signal value.

In order to determine the end of the time period, the variable tracks the signal value and when the signal value exceeds or falls below the variable value by the defined differential value, the end of the time period is determined, i.e., is set to the current time point. Thus the variable value is set equal to the signal value when the signal value exceeds or falls below the previous variable value. This is carried out for each signal value provided by the lambda probe or at least in defined time intervals. When the signal value falls below or exceeds the variable value, i.e., the previously existing maximum ,by the differential value, it can be concluded that the end of the time period is present. However, the differential value cannot be selected too small because the signal value is always subject to fluctuations or signal noise, which may lead to erroneous detection of the end of the time period in case of a too small differential value. Due to the differential value which has to be selected high enough it may occur that the end of the time period is recognized at a time point succeeding the actual end of the time period. This is in particular the case when the signal value provided by the lambda probe is delayed. Such a delay of the signal provided by the lambda probe can for example be due to transmission of the signal from the lambda probe to a control device in which the analysis of the signal or the signal value is carried out.

It is an object invention to propose a method for operating an exhaust gas purifying device, which does not have the aforementioned disadvantage, but enables in particular a more accurate determination of the end of the time period.

According to the invention, this is achieved with a method with the features of claim 1. It is provided that the end of the time period is corrected based on the time constant of the delay. It is thus provided to initially determine the end of the time period according to the above described approach. Subsequently the time constant of the delay is determined. Then the end of the time period is corrected by way of this time constant so that the influence of the delay is compensated at least partially, preferably entirely. The speed with which the signal value decreases depends in particular on the properties of the catalytic converter, the flow of exhaust gas impacting the lambda probe and the geometry of a protective pipe for the lambda probe which prevents that the exhaust gas directly flows onto the lambda probe. The greater the differential value has to be selected, for example due to noise or other influences on the signal value, the greater the deviation of the determined end of the time period from the actual end of the time period may be. This deviation can be decreased with the method described above. The time constant can for example be selected to be constant. However, it is particularly preferable to determine the time constant from the signal value or the course over time of the signal value. In this way the time constant can be adjusted to the actual operating conditions of the exhaust gas purifying device and for example aging of the lambda probe. With this such influences can be compensated almost entirely.

In addition or as an alternative multiple lambda probes can also be provided, wherein a lambda probe is arranged upstream of the catalytic converter and a further lambda probe is arranged downstream of the catalytic converter. In such an arrangement for example the period of time is determined which lies between the time point at which the maximum or the minimum of the corresponding signal value is determined by means of the upstream lambda probe and the time point at which the maximum or the minimum of the signal value of the downstream lambda probe occurs. Of course it can also be provided that the time period between setting the new fuel-air mixture at the internal combustion engine and the occurrence of the maximum or the minimum of the signal value is determined for each of the lambda probes.

A further refinement of the invention provides that the signal value is delayed by a filtering, and/or an arrangement of the lambda probe in the exhaust gas and/or the catalytic converter. The filtering is for example provided to decrease the background noise of the signal value provided by the lambda probe and to ensure a smooth course of the signal value. This enables a more reliable analysis of the signal value. On the other hand, this leads to a delay of the signal value which may lead to the fact that the actual end of the time period deviates from the determined end of the time period, and in particular temporally precedes the determined end of the time period. The delay can also be influenced by the arrangement of the lambda probe, for example when the exhaust gas due to flow conditions reaches the lambda probe with a delay after setting the new fuel-air mixture. This can in particular be due to the aforementioned protective tube. The catalytic converter also delays the signal value in the case when the lambda probe is arranged downstream of the catalytic converter.

In a refinement of the invention, the time constant is determined from the slope of the signal value. As explained above it is advantageous when the time constant is determined from the signal value or its course. It is provided that the slop of the signal value is determined over the time and with this conclusions are drawn from the present positive or negative slope regarding the time constant. The slope can in particular be determined form the derivation of the signal value. As an alternative it can also be determined form two signal values that lie at a predetermined temporal distance from each other in particular by using the corresponding straight line equation. For example the slope of the signal value is constantly determined and h e maximal value of the slope is used for determining the time constant. The maximal value is in particular a local maximal value which occurs in a defined time period prior to the end of the time period. This means that the maximal value of the slope is reset after determining the end of the time period or after correcting the end of the time period and is subsequently determined anew, i.e., is individually set for each time period. For example, the maximal value of the slope is reset at the beginning of the time period, i.e., exactly at the time point at which a new fuel air mixture is set at the internal combustion engine or the maximum or minimum of a further lambda probe which lies upstream of the lambda probe is determined. The above description analogously applies for a minimal value of the slope.

A refinement of the invention provides that a correction value for the end of the time period is determined from a differential value and the time constant. The differential value which when fallen below or exceeded by the variable value the end of the time period is determined as well as the time constant are relevant for the deviation when recognizing the end of the time period. Insofar both are to be taken into account for determining the correction value by means of which the end of the time period is corrected after it is determined. For example the correction value is added to the determined end of the time period or subtracted therefrom in order to obtain the corrected end of the time period. For example, it is provided that the correction value is the product of the differential value and the time constant. When the signal value is delayed by filtering, a course of the signal value λ over the time t can be described by the relationship

$$λ ( t ) = {λ}_{0} {e}^{\frac{t}{τ}}$$

wherein λ₀ for example equals 1. For example by way of this relationship the time constant tau can be determined. Subsequently the correction value Δt results from the relationship

Δt=Δλ·τ.

In a further refinement of the invention a binary lambda probe is used as lambda probe. In principle any lambda probe can be used, i.e., also a broadband lambda probe. However, preferably a lambda probe is used which operates within a narrow range of lambda. It only indicates whether lambda is greater than 1 or smaller than 1. The binary lambda probe can also be referred to as voltage jump probe.

The invention also relates to an exhaust gas purification device in particular for carrying out the method according to the afore described embodiments, with at least one catalytic converter for filtering exhaust gas and with at least one lambda probe arranged in the exhaust gas, wherein means are provided for determining a maximum or a minimum of a delayed signal value which is assigned to an end of a time period, in that a variable value tracks the signal value and when the signal value falls below or exceeds the variable value by a defined differential value the end of the time period is determined. The means are also configured to correct the end of the time period due to the time constant of the delay. The exhaust gas purifying device or the applied method can be refined according to the description above.

In the following, the invention is explained in more detail by way of the exemplary embodiments shown in the drawing without limiting the invention. It is shown in:

FIG. 1 a schematic representation of a region of an exhaust gas purifying device with a catalytic converter and two lambda probes.

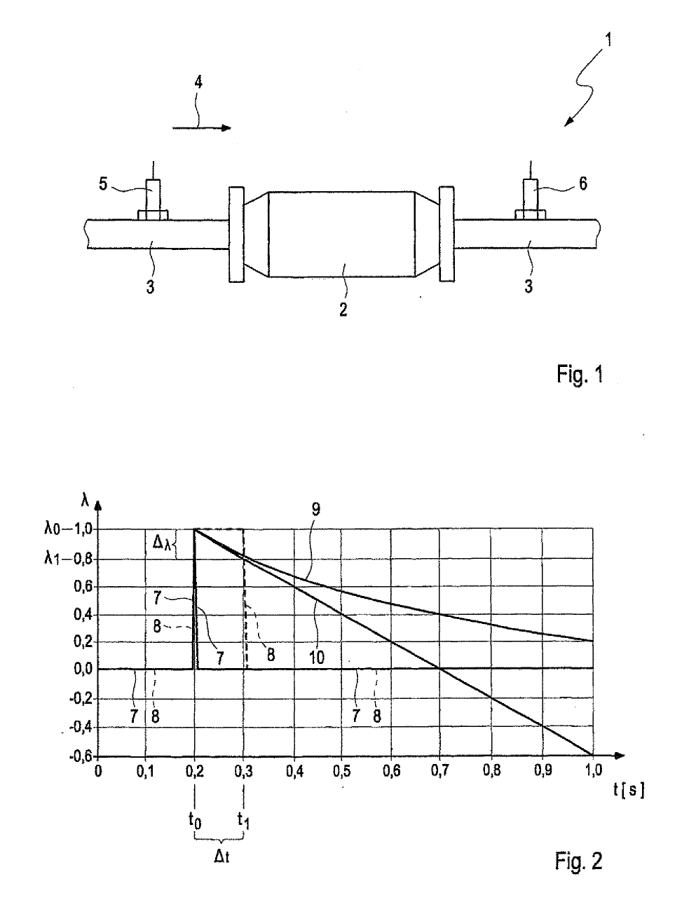

FIG. 2 a diagram in which a signal provided by the lambda probes is plotted against the time, and

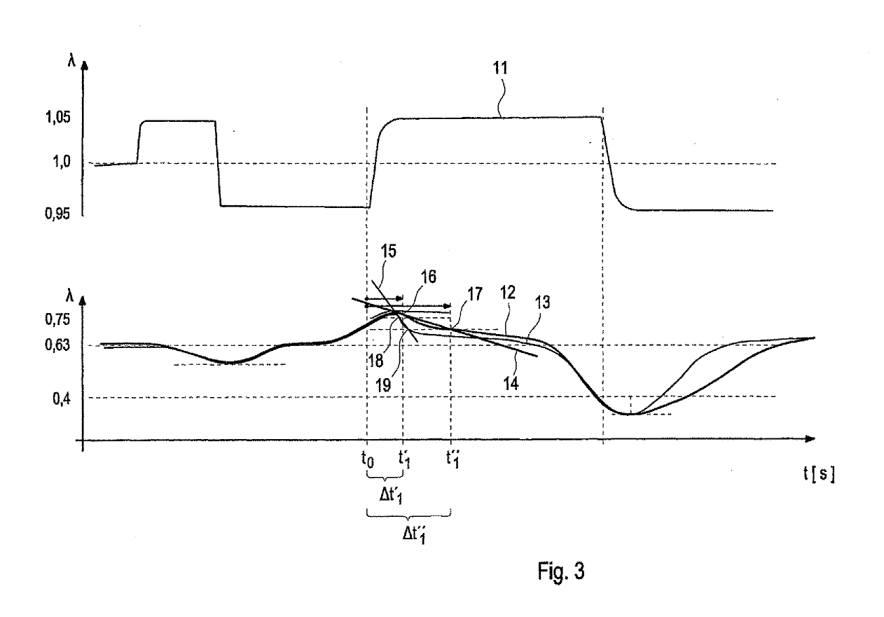

FIG. 3 a diagram in which the signals of two lambda probes are plotted over time.

FIG. 1 shows a schematic representation of an exhaust gas purifying device 1 with a catalytic converter 2, which is arranged in an exhaust gas line 3. The exhaust gas line 3 is connected to a here not shown internal combustion engine, with exhaust gas of the internal combustion engine flowing through the exhaust gas line 3 in the direction oft the arrow 4 during operation of the internal combustion engine. In the exhaust gas line 3 two lambda probes 5 and 6 are provided, wherein the lambda probe 5 s arranged upstream of the catalytic converter 2 and the lambda probe 6 downstream of the catalytic converter 2. Each lambda probe 5 and 6 can either be configured as broadband lambda probe or as binary lambda probe or voltage jump probe. The lambda probe 5 is used as regulating lambda probe i.e., it serves for adjusting the fuel-to-air ratio of the fuel-air mixture supplied to the internal combustion engine. On the other hand the lambda probe 6 serves as a monitoring probe and is used to monitor the function of the catalytic converter 2. During operation of the exhaust gas purifying device 1 the signal value provided by the lambda probe 5 can be compared with the signal value provided by the lambda probe 6. In a fully functional catalytic converter 2 a delayed reaction of the lambda probe 6 relative to the lambda probe 5 occurs. The time interval between the two reactions of the lambda probes 5 and 6 becomes shorter however when the catalytic converter 2 loses its storage capacity for example due to aging. As an alternative the lambda probe 6 can also be used for improving the regulation of the fuel and air proportions of the fuel-air mixture. A plausibilization of the signal values provided by the lambda probe 5 by means of the signal values provided by the lambda probe 6 and vise versa is conceivable.

The internal combustion engine can either be operated with a lean (λ>1), a stoichiometric (λ=1) or a rich (λ<1) fuel-air mixture. When a different fuel-air mixture is adjusted at the internal combustion engine, in particular when a change from a rich to a lean mixture occurs or vise versa, the time period is for example to be determined for the lambda probe 6 by which the reaction of the lambda probe is delayed relative to this adjustment.

For this purpose the associated end of the time period is determined from the signal value which is provided by the lambda probe to a control device with a delay by means of which the time period or the end of the time period is determined at a maximum or a minimum of the signal value the associated end of the time period is determined. For this purpose a variable value tracks the signal value and when the signal value falls below or exceeds the variable value by a defined differential value the end of the time period is determined. As mentioned before the end of the time period determined in this way may deviate from the actual end of the time period. This is in particular due to the delay of the signal value and the magnitude of the determined differential value. For this reason the end of the time period is to be corrected based on the time constant of the delay.

When the signal value is delayed by filtering, the signal value follows the course

$$λ ( t ) = {λ}_{0} {e}^{\frac{t}{τ}}$$

With t being the elapsed time, τ the time constant and λ₀ a starting value which is for example 1. The derivation of this course is given by the relationship

$$\frac{d λ ( t )}{d t} = - \frac{1}{τ} {e}^{- \frac{t}{τ}}$$

The maximal derivation of the signal value λ(t) is present at the time point t=0 and is given by

$${( \frac{d λ}{d t} )}_{max} = - \frac{1}{τ}$$

Correspondingly the time constant τ can be determined from this maximal derivation or the (preferably maximal) slope of the variable value λ(t).

From the time constant a correction value Δt can now be determined for the end of the time period. Wherein the following relationship applies

Δt=Δλ·τ,

wherein the determined differential value Δλ is used, which is also used for determining the end of the time period.

The described method is explained by way of the diagram of FIG. 2. In the diagram the air ratio λ or the corresponding signal value of the lambda probe 6 is plotted over the time t. A course 7 represents the actual course of the air ratio. Because the signal value is delayed however, the course 8 results which corresponds to the course 7 delayed in time. The signal value provided by the lambda probe 6 is delayed by a filtering so that it has the course 9. The actual end of the time period thus lies at the time point t₀=0.2 s. Because the signal value of the lambda probe 6 is delayed and the end of the time period is only determined when the signal value falls below the variable value by the differential value Δλ=0.2, with the signal value here corresponding to λ₀=1, the end of the time period is only determined at the time point t₁=0.3 s. Now the maximal value of the derivation

$$\frac{d λ}{d t}$$

is used to correct the determined end of the time period. The maximal value

$${( \frac{d λ}{d t} )}_{max}$$

of the derivation or the maximal derivation is present at the time point t₀. The course 10 represents this maximal derivation.

According to the foregoing the time constant τ=0.5 results from the maximal derivation or the slope because the maximal derivation or the maximal slope assumes the value −2 according to the course 10. The correction value for the determined end of the time period is now′

Δt=Δλ·τ=0.2·0.5=0.1 s.

With this value the determined end of the time period is corrected so that the actual end of the time period t₀ results instead of the determined end of the time period. Insofar the determination of the end of the time period is significantly improved by means of the method described above. For example the slope corresponds to the maximal derivation of the course of the signal values. However, it can also be calculated from two signal values that have are separated by a defined time interval.

FIG. 3 shows a diagram in which the signal values of two lambda probes are plotted over time, wherein a course 11 represent the signal values of the lambda probe 5 which is arranged upstream of the catalytic converter 2 and courses 12 and 13 represent signal values of the lambda probe 6 situated downstream of the catalytic converter 2. The course 12 shows a slower decrease of the signal value after reaching a maximum after the time point t₀, while the course 13 has a faster decrease. Correspondingly a straight line 14, which represents the slope of the course 12, is shallower than a straight line 15, which represents the slope of the course 13. The slopes 14 and 15 are determined by way of the signal values and the corresponding time points, which are indicated by reference numerals 16 and 17 or 18 and 19. From slopes 14 and 15 corresponding time constant are determined and—as mentioned before—are used for correcting the respective determined end of the time period t′1 (course 13) or respectively t″1 (course 12).

### LIST OF REFERENCE SIGNS

1 exhaust gas purification device
2 catalytic converter
3 exhaust gas line
4 arrow
5 lambda probe
6 lambda probe
7 course
8 course
9 course
10 course
11 course
12 course
13 course
14 straight line
15 straight line
16 signal value
17 signal value
18 signal value
19 signal value

What is claimed is:

1.-6. (canceled)

7. A method for operating an exhaust gas purifying device with at least one catalytic converter for filtering exhaust gas, comprising:
generating a signal value with at least one lambda probe arranged in the exhaust gas;
tracking the signal value at a time delay with a predetermined variable value during a time period so that the variable value represents a minimum or a maximum of the signal value;
defining an end of the time period as a time point at which the tracked signal value falls below or exceeds the variable value by a defined differential value;
determining a time constant as a function of the time delay; and
correcting the end of the time period based on the time constant.

8. The method of claim 7, wherein the time delay is a result of at least one of a filtering, an arrangement of the at least one lambda probe in the exhaust gas and the catalytic converter.

9. The method of claim 7, wherein the time constant is determined from a slope of the tracked signal value.

10. The method of claim 7, further comprising determining a correction value for the end of the time period from the differential value and the time constant.

11. The method of claim 7, wherein the lambda probe is constructed as a binary lambda probe.

12. An exhaust gas purifying device, comprising:
at least one catalytic converter for filtering exhaust gas;
at least one lambda probe arranged in the exhaust gas, said lambda probe generating a signal value, said signal value being delayed by a delay; and
means configured for
tracking the signal value with a predetermined variable value during a time period so that the variable value represents a minimum or a maximum of the signal value;
defining an end of the time period as a time point at which the tracked signal value falls below or exceeds the variable value by a defined differential value;
determining a time constant as a function of a time delay between the generating of the signal value and the tracking of the signal value; and
correcting the end of the time period based on the time constant.
